(19) United States
(12) Patent Application Publication
(10) Pub. No.: US 2023/0360873 A1
(43) Pub. Date: Nov. 9, 2023

(54) ADAPTER FOR INSTALLING AN ACCESSORY PART AND ELECTRICAL SWITCH HAVING SUCH AN ADAPTER

(71) Applicant: Siemens Aktiengesellschaft, München (DE)

(72) Inventors: Ekkehard Plechinger, Röckersbühl (DE); Thomas Bunk, Sulzbach-Rosenberg (DE)

(21) Appl. No.: 18/313,495

(22) Filed: May 8, 2023

(30) Foreign Application Priority Data
May 6, 2022 (DE) 10 2022 204 479.7

(51) Int. Cl. H01H 71/02; H01H 71/52; H01H 71/46; H01H 9/28

(52) U.S. Cl. CPC H01H 71/0228; H01H 71/52; H01H 71/465; H01H 9/28

(57) ABSTRACT

An adapter for installing at least one accessory part into an electrical switch. The accessory part has at least one interface and the electrical switch has a housing and at least one actuation element. The adapter has at least one deflection gear mechanism, which, when the adapter is installed in the housing of the electrical switch, is arranged in an operatively connecting manner between the at least one interface of the accessory part and the at least one actuation element of the electrical switch.

### CROSS-REFERENCE TO RELATED APPLICATION

This application claims the priority, under 35 U.S.C. § 119, of German Patent Application DE 10 2022 204 479.7, filed May 6, 2022; the prior application is herewith incorporated by reference in its entirety.

### FIELD AND BACKGROUND OF THE INVENTION

The invention relates to an adapter for installing at least one accessory part into an electrical switch and to an electrical switch having an adapter of this kind.

Modern circuit breakers typically have, depending on their number of poles, recesses or what are known as pockets to the left and/or right of their actuator, into which internal accessories can be installed. These recesses or pockets are usually covered and closed off by a cover after being fitted with the accessories.

In typical configurations, single-pole switches do not have any accessory pockets, two-pole switches have one accessory pocket, which is arranged to the right or to the left of the actuator, three-pole electrical switches have one accessory pocket to the right and one to the left of the actuator, and four-pole electrical switches have one or two accessory pockets to the left of the actuator and one accessory pocket to the right of the actuator. Depending on the size of the switch, each accessory pocket can again be divided into a plurality of slots for associated internal accessories.

Typical internal accessories can be auxiliary switches on the one hand, but also shunt trips, communication accessories or locking mechanisms.

By way of example, auxiliary switches can be ON/OFF auxiliary switches (AUX) that indicate the ON/OFF state of the electrical switch; trip alarm switches (TAS) that indicate the trip state of the electrical switch; leading changeover switches (LCS) that indicate in advance if the electrical switch is being switched off; electrical alarm switches (EAS) that indicate if the ETU (electronic trip unit) has tripped, or short-circuit alarm switches (SAS) that indicate if the TMTU has tripped.

Typical shunt trips can be undervoltage releases (UVR, UNI), which trip in the event of undervoltage, or shunt releases (SHT, STL, STF), which trip in the event of voltage threshold values.

By way of example, typical communication accessories for electrical circuit breakers are communication modules (COM module), which ensure communication with electronic assemblies, or power supply modules (24 V module), which serve to supply power to the ETU.

By way of example, a typical locking mechanism is a cylinder locking mechanism that is used to lock the actuator in the ON or OFF position of the electrical switch.

For controlling and activating the different internal accessories, in the case of electrical switches, a wide variety of interfaces from the switch interior to the accessory pockets or, conversely, from the accessory pockets to the switch interior, have to be developed.

FIG. 1 show a typical old-generation circuit breaker 1000. The electrical switch 1000 can be fitted with a plurality of auxiliary switches 201 using different adapters 100′, 100″. There are only auxiliary switches 201 that can be used as ON/OFF switches or as trip alarm switches. Whether an auxiliary switch 201 is used as an ON/OFF switch or as a trip alarm switch is determined by selecting the corresponding installation adapter 100′, 100″. There are opener versions and closer versions of the auxiliary switches 201.

With reference to FIG. 2, a multiplicity of types of different internal accessories 201; 202; 203; . . . ; 215 can be inserted in new-generation circuit breakers 1000. The accessories 201; 202; 203; . . . ; 215 are intended to be installed in the electrical switch 1000. It was ensured that the same internal accessories 201; 202; 203; . . . ; 215 can be used for all sizes. In order to be able to fit as many internal accessories as possible, the internal accessories 201; 202; 203; . . . ; 215 were also reduced in terms of size and volume.

As a result of the fact that the developed internal accessories 201; 202; 203; . . . ; 215 of a new-generation electrical switch 1000 according to FIG. 2 are reduced in terms of size and volume, these can, for example, also be used in old-generation electrical switches 1000 according to FIG. 1 if the activating elements are adapted correspondingly.

### SUMMARY OF THE INVENTION

It is accordingly an object of the invention to provide an adapter which overcomes a variety of disadvantages of the heretofore-known devices and methods of this general type and which provides an adapter for installing at least one accessory part into an electrical switch, which adapter can accommodate a multiplicity of accessory parts and, through its functionality, allows the accessory parts to interact with the electrical switch.

With the above and other objects in view there is provided, in accordance with the invention, an adapter for installing at least one accessory part into an electrical switch; the switch having a housing and at least one actuation element, and the at least one accessory part having at least one interface. The adapter comprises:

at least one deflection gear mechanism, which, when the adapter is installed in the housing of the electrical switch, is operatively connected between the at least one interface of the at least one accessory part and the at least one actuation element of the electrical switch.

In other words, an adapter for installing at least one accessory part into an electrical switch has at least one accessory part with at least one interface, the electrical switch comprises a housing and at least one actuation element, at least one deflection gear mechanism, which, when an adapter is installed in the housing of the electrical switch, is arranged in an operatively connecting manner between the at least one interface of the at least one accessory part and the at least one actuation element of the electrical switch.

It is advantageous in this case that, by using modern new-generation accessories, individual old-generation electrical switches can continue to be used as new-generation electrical switches. This makes it possible to save on redevelopment for switch sizes in low quantities. Furthermore, it is possible to integrate new accessories into existing switch series; this allows old accessories to be discontinued. Accessories can be installed into electrical switches from different manufacturers by means of the adapter according to the invention; this allows an additional outlet for accessories to be generated.

In one configuration of the adapter according to the invention, the adapter comprises an adapter housing that can be installed into the housing of the electrical switch. The adapter housing can have a one-part design or a two-part design, with a lower part that can be releasably installed into the housing of the electrical switch, and with an upper part that can be installed on this lower part. If the upper part is installed, the upper part can block the lower part from being released from the electrical switch

In one configuration of the adapter according to the invention, the at least one accessory part can be installed in pockets of the adapter housing.

In a further configuration of the adapter according to the invention, the at least one deflection gear mechanism transmits the forces or the travels in a ratio of 1:1, with a boosting effect, or with a reducing effect.

In accordance with an added feature of the invention, the at least one deflection gear mechanism can actuate at least two interfaces of the accessory parts at the same time.

In accordance with an additional feature of the invention, the at least one actuation element is in the form of a tripping shaft, a breaker shaft, or a lever.

In accordance with a further feature of the invention, the adapter is configured to accommodate, as an accessory part, an ON/OFF auxiliary switch (AUX), a trip alarm switch (TAS), a leading changeover switch (LCS), an electrical alarm switch (EAS), or a short-circuit alarm switch (SAS).

In accordance with yet an added feature of the invention, the adapter is configured to accommodate, as an accessory part, an undervoltage release (UVR, UNI), a shunt release (SHT, STL, STF), a communication module (COM module) or a power supply module (24 V module).

In accordance with a concomitant feature of the invention, the adapter is designed to accommodate, as an accessory part, a cylinder locking mechanism that is used to lock an actuator in the ON or OFF position of the electrical switch.

With the above and other objects in view there is also provided, in accordance with the invention, an electrical switch having an adapter according to the invention which is installed in a recess of the housing of the electrical switch.

Other features which are considered as characteristic for the invention are set forth in the appended claims.

Although the invention is illustrated and described herein as being embodied in an adapter for installing an accessory part and an electrical switch having an adapter of this kind, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows an old-generation electrical switch having auxiliary switches;

FIG. 2 shows a new-generation electrical switch having a multiplicity of different accessory parts;

FIGS. 3A and 3B show a new-generation electrical switch having an auxiliary switch and an old-generation electrical switch having a larger auxiliary switch in a recess or pocket;

FIG. 4 shows an old-generation electrical switch having an adapter according to the invention and new-generation accessory parts;

FIGS. 5A and 5B show an adapter according to the invention having a two-part housing and a deflection gear mechanism;

FIGS. 6A and 6B show a lower part of the adapter according to the invention having a deflection gear mechanism and an upper part installed on the lower part of the adapter;

FIGS. 7A and 7B show an electrical switch having a recess for an adapter and installed lower part of the adapter installed in the electrical switch;

FIGS. 8A and 8B show an installed upper part and accessory parts installed in the adapter;

FIGS. 9A and 9B show an alternative adapter according to the invention having an upper part and a lower part before installation and after installation; and

FIGS. 10A and 10B show an electrical switch having an adapter according to the invention and installed accessory parts to the right and to the left of the actuator.

### DETAILED DESCRIPTION OF THE INVENTION

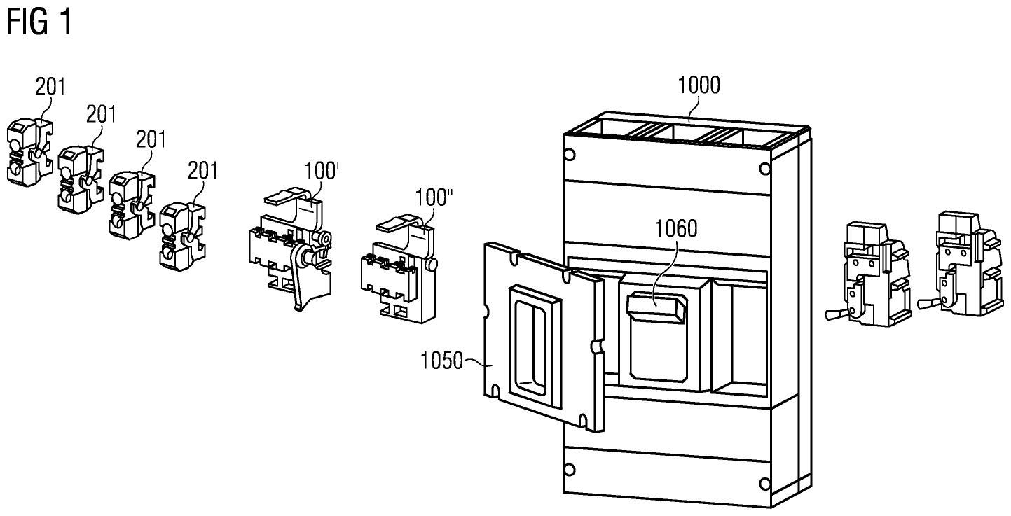

Referring once more to FIG. 1 of the drawing, there is shown an old-generation electrical switch 1000. The electrical switch 1000 can be switched between the ON and the OFF positions by way of an actuator 1060. Next to the actuator 1060, there are recesses or pockets in which accessory parts such as auxiliary switches, for example, can be installed. In order to be able to install these auxiliary switches 201 in the recesses or pockets, an installation adapter 100′; 100″ is required depending on whether the auxiliary switches 201 are intended to be used as ON/OFF auxiliary switches or as trip alarm switches. The recesses or pockets for the auxiliary switches 201 can be closed off or covered by way of a housing cover 1050.

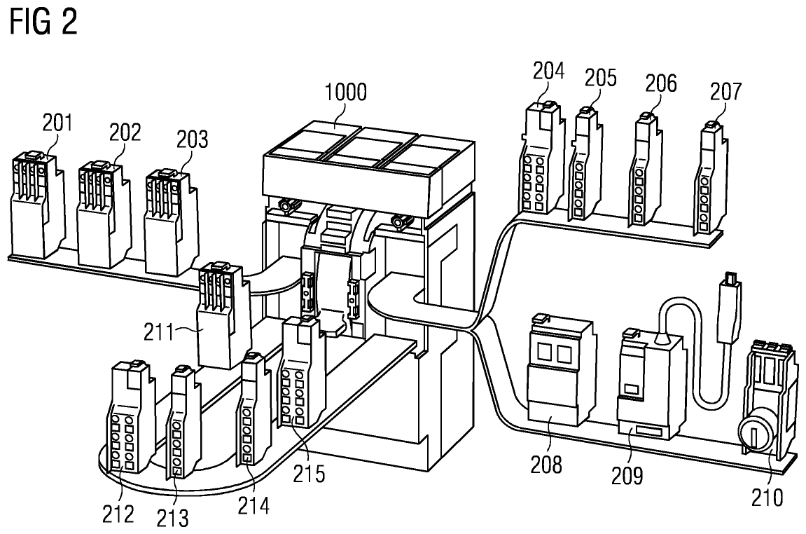

FIG. 2 likewise shows an electrical switch 1000 which, in contrast with FIG. 1, is a new-generation electrical switch 1000. In this case, there is a miniaturization of the accessory parts and a wide variety of different accessory parts 201, 202, 203, . . . , 215.

The accessory parts may be auxiliary switches, shunt trips, communication accessories, or locking mechanisms. On account of the ongoing miniaturization of the electrical switches 1000, these accessory parts 201, 202, 203, . . . , 215, and therefore the recesses or pockets in which these parts are installed, are physically smaller than in the case of the old-generation switch 1000 of FIG. 1.

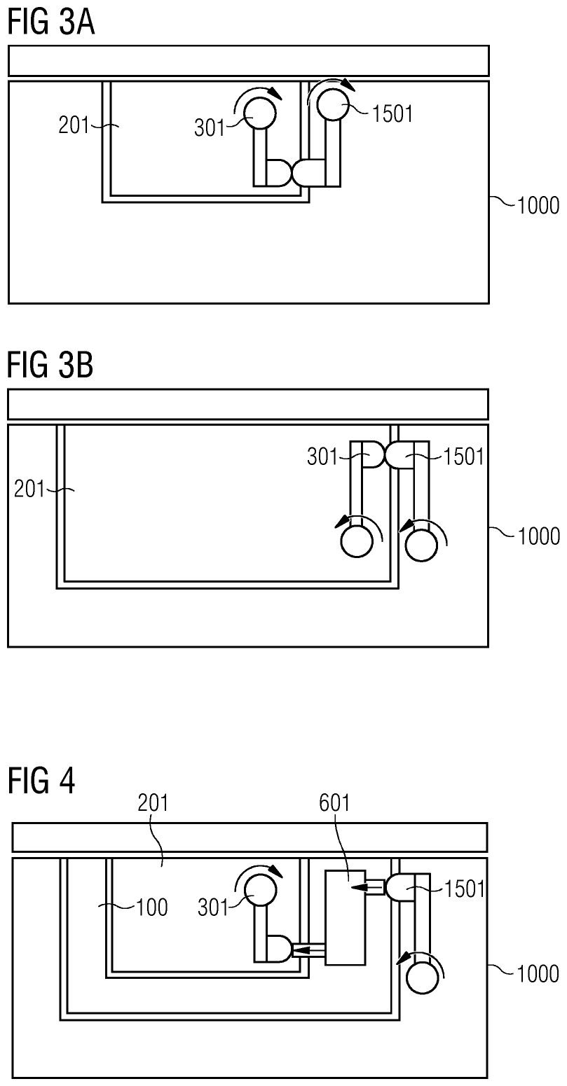

This is illustrated schematically in FIGS. 3A and 3B. FIG. 3A shows a new-generation electrical switch 1000 with an accessory part 201 that is operatively connected to an actuation element 1501 of the electrical switch 1000 via an interface 301. The same applies to the old-generation electrical switch 1000 according to FIG. 3B, except that the installation space of the accessory part 201 is correspondingly greater.

FIG. 4 also shows the old-generation electrical switch 1000 with an actuation element 1501 and an inserted and installed adapter 100, according to the invention, in which an accessory part 201 is installed. The adapter comprises a deflection gear mechanism 601, which, if an adapter 100 is installed in the housing 1010 of the electrical switch 1000, is arranged in an operatively connecting manner between the interface 301 of the accessory part 201 and the actuation element 1501 of the electrical switch 1000.

The deflection gear mechanism 601 can transmit the forces or the travels in a ratio of 1:1, with a boosting effect or with a reducing effect. By way of example, the deflection gear mechanism 601 can act as a booster that boosts the forces of an accessory part 201 and therefore trips an electrical switch of a relatively large assembly. In the case of a transmission of the forces or the travels in a ratio of 1:1 of the deflection gear mechanism 601, this means a spatial adaptation as is also shown schematically by the displacement of the actuation element 1501 to the interface 301 in FIG. 4. The interface 301 and the actuation element 1501 can therefore be arranged so as to be offset and the deflection gear mechanism 601 arranged between them can effect this spatial implementation.

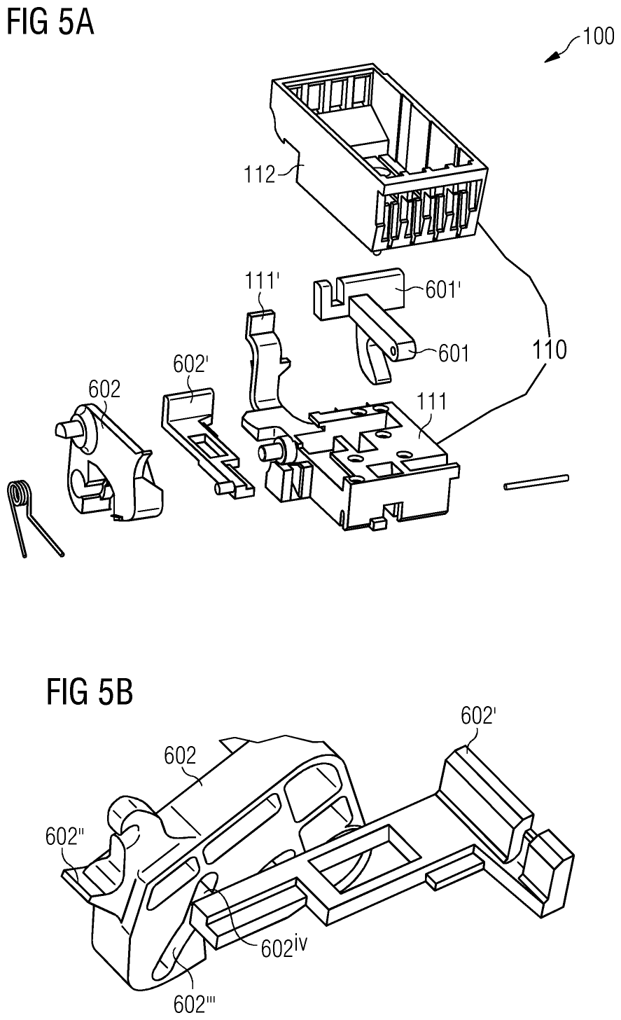

FIG. 5A shows an embodiment of an adapter 100 according to the invention. The adapter 100 comprises an adapter housing 110 that can be installed into the housing 1010 of the electrical switch 1000. According to the depiction in FIG. 5A, the adapter housing 110 has a two-part design, with a lower part 111 that can be releasably installed into the housing 1010 of the electrical switch 1000, and with an upper part 112 that can be installed on this lower part 111.

Furthermore, the adapter 100 comprises deflection gear mechanisms 601; 602, 602′. The deflection gear mechanism 601 is mounted so as to be rotatable about an axis and interacts with an actuation element of the electrical switch 1000. The deflection gear mechanism 601 can be designed in such a way that at least two interfaces 301; 302 of the accessory parts 201; 202 are actuated at the same time. According to the depiction in FIG. 5A, this is realized by virtue of the deflection gear mechanism 601 having a wide lever 601′, by means of which the plurality of accessory parts 201; 202 can be actuated.

The further deflection gear mechanism 602, 602′, which is shown in more detail in FIG. 5B, has a two-part design. By means of a pin 602″ running in a race contour 602—, there is in this case likewise a transmission of the force or of the travel between the interface 301 of the accessory part 201 and the actuation element 1501 of the electrical switch 1000. A latching lever 602″ that interacts with an actuation element of the electrical switch 1000 can be provided on the deflection gear mechanism 602.

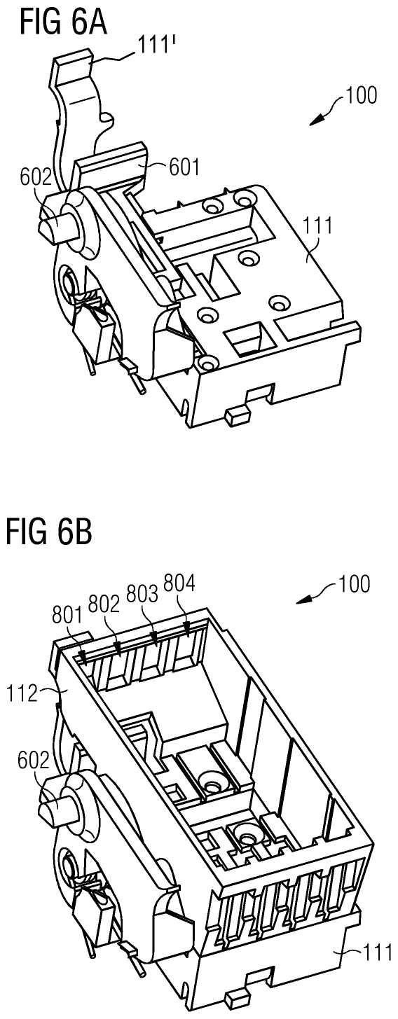

The adapter 100 according to the invention is shown in FIG. 6A with deflection gear mechanisms 601; 602 installed on the lower part 111. According to the depiction in FIG. 6B, the upper part 112 of the adapter 100 can be installed on the lower part 111. This upper part 112 has pockets 801; 802; 803; 804 into which accessory parts 201; 202; 203; 204 can be inserted. According to the depiction in FIG. 6B, the interfaces 301; 302; 303; 304 of the accessory parts 201; 202; 203; 204 are directed downward in the direction of the deflection gear mechanisms 601; 602 of the adapter 100, such that an operative connection is produced.

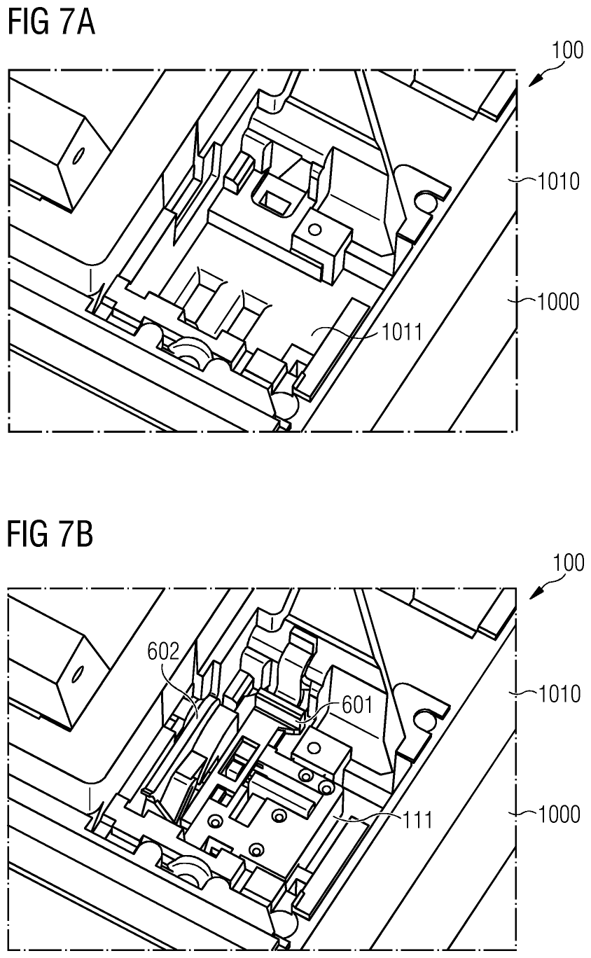

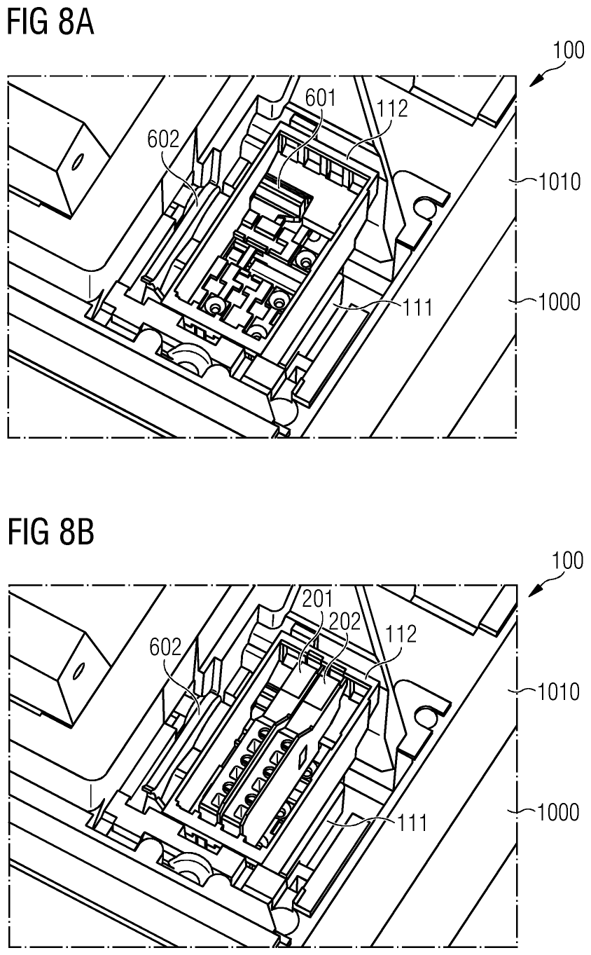

FIGS. 7A, 7B, 8A and 8B show the installation of the adapter 100 according to the invention in a recess or pocket 1011 of the housing 1010 of an electrical switch 1000.

FIG. 7A shows the electrical switch with the recess or pocket 1011. FIG. 7B shows the adapter 100 according to the invention or the lower part 111 thereof installed in the recess 1011 of the electrical switch 1000. The deflection gear mechanisms 601; 602 are installed on the lower part 111. FIG. 8A shows that the upper part 112 is installed on the lower part 111 such that accessory parts 201; 202 can be inserted and installed therein according to the depiction in FIG. 8B.

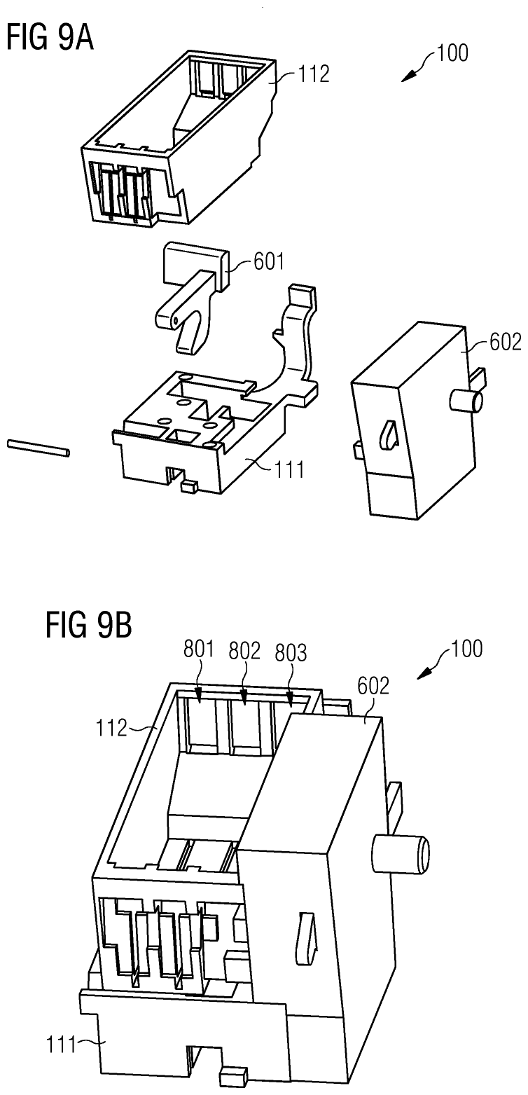

FIGS. 9A and 9B show a further embodiment of an adapter 100 according to the invention. FIG. 9A shows the adapter 100 with a lower part 111, an upper part 112, a deflection gear mechanism 601 and a further deflection gear mechanism 602. FIG. 9B shows the installed adapter 100 according to the invention. In FIGS. 9A and 9B, the adapter 100 according to the invention has pockets 801; 802; 803 in the adapter housing 110; 111, 112, in which accessory parts 201; 202; 203 can be installed.

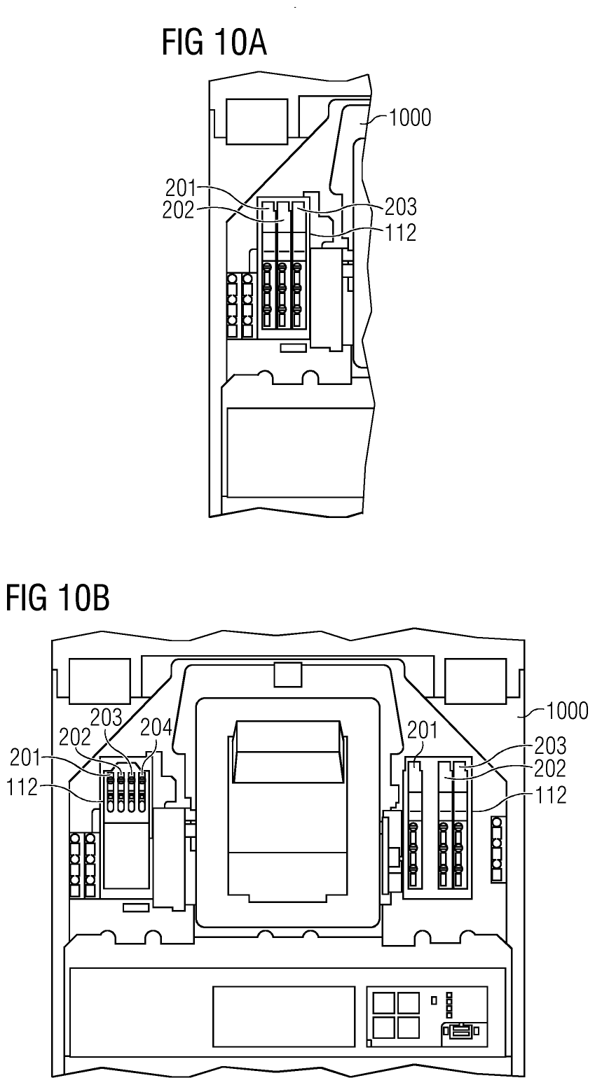

In a plan view of an electrical switch 1000, FIG. 10A shows a left-hand recess or pocket of the electrical switch 1000, in which recess or pocket the adapter 100 according to the invention is installed. According to the depiction in FIG. 10A, the upper part 112 of the adapter 100 is visible. Accessory parts 201; 202; 203 are inserted in the pockets of the adapter 100 according to the invention.

In the case of an electrical switch 1000 from a relatively large series or a multi-pole variant, pockets to the left and to the right of the actuator can be provided with an adapter 100 according to the invention. According to FIG. 10B the left-hand adapter 100 can, for example, accommodate four accessory parts 201; 202; 203; 204 The right-hand adapter 100 can, for example, accommodate three accessory parts 201; 202; 203.

By way of example, the actuation element or elements 1501 may be a tripping shaft of the electrical switch 1000, a breaker shaft of the electrical switch 1000, or a lever of the electrical switch 1000.

In the case of a two-part adapter 100, according to the invention, with a lower part 111 and an upper part 112, when the upper part 112 is installed, the upper part can block the lower part 111 from being released from the electrical switch 1000. By way of example, the lower part 111 can be installed in a latching manner on the electrical switch 1000 using a snap-fit connection, wherein a latch lever 111′ (cf. FIGS. 5A, 6A) can no longer be opened once the upper part 112 has been installed.

The adapter housing 110 can also have a one-part design and, for example, can be produced by means of an additive manufacturing method such as the 3D printing method.

The adapter 100 according to the invention can be designed to accommodate, as an accessory part 201; 202; 203; . . . ; 215, an ON/OFF auxiliary switch (AUX), a trip alarm switch (TAS), a leading changeover switch (LCS), an electrical alarm switch (EAS) or a short-circuit alarm switch (SAS).

The adapter 100 according to the invention can also be designed to accommodate, as an accessory part 201; 202; 203; . . . ; 215, an undervoltage release (UVR, UNI), a shunt release (SHT, STL, STF), a communication module (COM module) or a power supply module (24 V module).

The adapter 100 according to the invention can also be designed to accommodate, as an accessory part 201; 202; 203; . . . ; 215, a cylinder locking mechanism that makes it possible to lock an actuator 1060 in the ON or OFF position of the electrical switch 1000.

An adapter 100 according to the invention is realized, which externally geometrically fits into the accessory pocket or recess 1011 of an old-generation electrical switch 1000, and internally is configured such that it can accommodate new-generation accessory parts 201; 202; 203; . . . ; 215. Furthermore, there are deflection gear mechanisms 601; 602 . . . situated within the adapter 100 that can output forces and travels from actuation elements 1501 . . . of the electrical switch 1000 to new-generation accessory parts 201; 202; 203; . . . ; 215. The adapter 100 according to the invention also functions in a reverse mode of operation if forces and travels are output from the internal accessory to the circuit breaker 1000. By way of example, this is the case for shunt trips, in which case a plunger of the shunt trip has to trip the switch. If the force of the shunt trip is too weak, the force of the plunger can be boosted in this case using a booster unit (booster).

1. An adapter for installing at least one accessory part into an electrical switch, the switch having a housing and at least one actuation element, and the at least one accessory part having at least one interface, the adapter comprising:
at least one deflection gear mechanism, which, when the adapter is installed in the housing of the electrical switch, is operatively connected between the at least one interface of the at least one accessory part and the at least one actuation element of the electrical switch.

2. The adapter according to patent claim 1, further comprising an adapter housing configured for installation into the housing of the electrical switch.

3. The adapter according to claim 2, wherein said adapter housing has a one-part design.

4. The adapter according to claim 2, wherein said adapter housing has a two-part design, with a lower part to be releasably installed into the housing of the electrical switch, and an upper part to be installed on said lower part.

5. The adapter according to claim 4, wherein, when said upper part is installed, said upper part blocks said lower part from being released from the electrical switch.

6. The adapter according to claim 2, wherein said adapter housing is formed with pockets and said at least one accessory part is configured for installation in at least one of said pockets of said adapter housing.

7. The adapter according to claim 1, wherein said at least one deflection gear mechanism is configured to transmit forces or travels in a ratio of 1:1, with a boosting effect, or with a reducing effect.

8. The adapter according to claim 1, wherein said at least one deflection gear mechanism is configured to simultaneously actuate at least two interfaces of the accessory part.

9. The adapter according to claim 1, wherein said at least one actuation element is at least one element selected from the group consisting of a tripping shaft, a breaker shaft, and a lever.

10. The adapter according to claim 1, wherein the adapter is configured to accommodate, as an accessory part, at least one switch selected from the group consisting of an ON/OFF auxiliary switch, a trip alarm switch, a leading changeover switch, an electrical alarm switch, and a short-circuit alarm switch.

11. The adapter according to claim 1, wherein the adapter is configured to accommodate, as an accessory part, at least one element selected from the group consisting of an undervoltage release, a shunt release, a communication module, and a power supply module.

12. The adapter according to claim 1, wherein the adapter is configured to accommodate, as an accessory part, a cylinder locking mechanism that is used to lock an actuator in an ON position or an OFF position of the electrical switch.

13. An electrical switch, comprising:
a housing formed with a recess; and
an adapter according to claim 1 installed in said recess of said housing.
